(19) United States
(12) Patent Application Publication
(10) Pub. No.: US 2024/0328544 A1
(43) Pub. Date: Oct. 3, 2024

(54) FLEXIBLE TUBE

(71) Applicant: TOYOX CO., LTD., Toyama (JP)

(72) Inventor: Kenichi NUMATA, Toyama (JP)

(21) Appl. No.: 18/744,021

(22) Filed: Jun. 14, 2024

Related U.S. Application Data
(63) Continuation of application No. PCT/JP2022/040627, filed on Oct. 31, 2022.

(30) Foreign Application Priority Data
Dec. 17, 2021 (JP) 2021-205032

(51) Int. Cl. F16L 11/06; F16L 11/12

(52) U.S. Cl. CPC F16L 11/06; F16L 11/12

(57) ABSTRACT

A flexible tube has a styrene-based elastomer as a main component, which is formed by extrusion molding so that a draw down ratio in an inner diameter will be 0.8 to 1.1, and an arithmetic average roughness Ra of an inner surface of the flexible tube is 1.5 μm or less, and a maximum height Rz of an inner surface of the flexible tube is 7 μm or less, and an amount of evaporation residue except for heptane in the flexible tube, which is measured in accordance with a test method in Standards and criteria for food and food additives, etc. (Ministry of Health, Labour and Welfare Notification No. 380 on Dec. 4, 2020), is 30 μg/ml or less, and a ratio of the maximum height Rz to the arithmetic average roughness Ra of an inner surface of the flexible tube Rz/Ra is 3.9 or less.

### CROSS-REFERENCE TO RELATED APPLICATION

This patent application is a bypass continuation of PCT International Application No. PCT/JP2022/040627 filed on Oct. 31, 2022, which claims the benefit of priority under 35 USC 119 of Japanese Patent Application No. 2021-205032 filed on Dec. 17, 2021, the entire contents of both of which are incorporated herein by reference for all purposes.

### BACKGROUND

### Technical Field

The present disclosure relates to a flexible tube.

### Description of the Related Art

Flexible tubes used for various uses and having flexibility have been suggested in the past. Japanese Patent No. 5475794 for example discloses a multilayer flexible tube, which includes the first layer including a polyolefin material and the second layer including a blend of a propylene polymer and a styrene block copolymer. This multilayer flexible tube does not include a polyvinyl chloride-based material, which therefore prevents e.g. the generation of deleterious materials associated with the incineration of the polyvinyl chloride-based flexible composition, and the migration of the composition into the tube, and reduces concern for environments and health. Additionally, Japanese Patent No. 4169840 for example discloses a laminated tube, which includes an inner layer including an ethylene-methacrylic acid copolymer (EMMA) and an outer layer including an ethylene-vinyl acetate copolymer (EVA).

### SUMMARY

According to an aspect of the present disclosure, there is provided a flexible tube having a styrene-based elastomer as a main component, which is formed by extrusion molding so that a draw down ratio in an inner diameter will be 0.8 to 1.1, wherein an arithmetic average roughness Ra of an inner surface of the flexible tube is 1.5 μm or less, and a maximum height Rz of an inner surface of the flexible tube is 7 um or less, an amount of evaporation residue except for heptane in the flexible tube, which is measured in accordance with a test method in Standards and criteria for food and food additives, etc. (Ministry of Health, Labour and Welfare Notification No. 380 on Dec. 4, 2020), is 30 μg/ml or less, and a ratio of the maximum height Rz to the arithmetic average roughness Ra of an inner surface of the flexible tube Rz/Ra is 3.9 or less.

### BRIEF DESCRIPTION OF THE DRAWINGS

FIG. 1 is a cross-sectional view of an example of a mold used to produce the flexible tube according to an embodiment.

### DESCRIPTION OF THE EMBODIMENTS

Below, the flexible tube according to the present disclosure is described in comparison with the related technology. When a flexible tube is used for a roller pump in e.g. food manufacturing, since the flexible tube is compressed and thus worn and a resin composition forming the flexible tube migrates, a fluid in the flexible tube is easily contaminated with said resin composition. Therefore, non-migration properties are considered a particularly important issue from the viewpoint of hygiene. Furthermore, since the flexible tube is repeatedly compressed and thus is under load, compression recovery properties of the compressed flexible tube are also required. When the above multilayer flexible tube in Japanese Patent No. 5475794 and the above laminated tube in Japanese Patent No. 4169840 are used as a flexible tube for roller pumps, since the flexible tube is repeatedly compressed and repeatedly stressed, there is a risk that a resin composition forming the flexible tube will migrate into a fluid in the flexible tube, and there is also a risk that sufficient compression recovery properties cannot be obtained.

To solve the problems of the related technology mentioned above, the flexible tube of the present disclosure is a flexible tube having a styrene-based elastomer as a main component, wherein the arithmetic average roughness Ra of the inner surface of the flexible tube is 1.5 μm or less, and the maximum height Rz of the inner surface of the flexible tube is 7 μm or less.

According to the configuration of the present disclosure, it is possible to provide a flexible tube with excellent non-migration properties, which has good compression recovery properties, and is suitably used as a flexible tube for roller pumps.

An embodiment of the present disclosure will be described below with reference to the drawings. The flexible tube according to the embodiment of the present disclosure is a flexible tube used for e.g. a roller pump, and is formed from a flexible tube having a styrene-based elastomer as a main component. The arithmetic average roughness Ra of the inner surface of this flexible tube is 1.5 um or less. It should be noted that the “main component” in the specification refers to a component in an amount of 50 mass % or more with respect to the total amount. That is, the flexible tube according to the embodiment is formed from a flexible tube containing a styrene-based elastomer in an amount of at least 50 mass % or more.

The roller pump is termed e.g. tube pump, tubing pump, hose pump, peristaltic pump, peristaltic type pump and is formed from a flexible tube and a roller with a plurality of projections. The roller pump is a pump which transport a fluid by pressing the flexible tube with the projections as the roller pump rotates, and pushing the fluid in the flexible tube.

The styrene-based elastomer is a material with excellent elasticity, transparency and chemical resistance. Because of this, it is suitable as a material of a flexible tube for roller pumps, which is required to have e.g. compression recovery properties, transparency, non-migration properties.

Examples of the styrene-based elastomer include a styrene-butadiene-styrene block copolymer (SBS), a styrene-isoprene-styrene block copolymer (SIS), a styrene-ethylene·butylene-styrene block copolymer (SEBS), a styrene-ethylene·propylene-styrene block copolymer (SEPS) and the like. These can be used individually or two or more of them can be used in combination.

It should be noted that e.g. a polyolefin and a plasticizer (softener) can be contained in the flexible tube as compositions other than the styrene-based elastomer.

Additionally, when the arithmetic average roughness Ra of the inner surface of a flexible tube is 1.5 um or less, the area coming into contact with a fluid is reduced, and excellent non-migration properties can be achieved. If the surface roughness of the inner surface of a flexible tube is high, the flexible tube is repeatedly compressed by a roller pump, and thus the inner surfaces of the flexible tube vigorously rub against each other, which removes parts of the surfaces. Therefore, there is a risk that a fluid flowing inside the flexible tube will be contaminated with the components of the flexible tube. In the flexible tube of the present embodiment, on the other hand, when the surface roughness of the inner surface of the flexible tube is a value within the above range, the smoothness of the inner surface is high, and friction between the inner surfaces when the flexible tube is compressed becomes smaller. Therefore, the friction resistance between the inner surfaces can be suppressed. Furthermore, pipe friction with respect to a fluid inside the flexible tube can be reduced. Therefore, the fluid in the flexible tube can be prevented or suppressed from being contaminated with the components of the flexible tube.

Additionally, when the maximum height Rz of the inner surface of the flexible tube is 7 μm or less and moreover the arithmetic average roughness Ra is 1.5 μm or less, the smoothness of the inner surface of the flexible tube can be more improved. Because of this, more excellent non-migration properties can be achieved.

Furthermore, when the ratio of the maximum height Rz to the arithmetic average roughness Ra of the inner surface of the flexible tube Rz/Ra is 10 or less, there are a few irregularities on the inner surface, pipe friction with respect to a fluid flowing inside the flexible tube can be reduced, and the amount of fluid discharged can be improved. Therefore, contamination from the inside can be reduced.

The arithmetic average roughness Ra of the outer surface of the flexible tube is preferably 20 um or less. When the arithmetic average roughness Ra of the outer surface of the flexible tube is as described above, the smoothness of the outer surface is high, and the generation of e.g. cracks on the outer surface of the flexible tube, which is caused when the flexible tube is repeatedly compressed by a roller pump, can be prevented or suppressed.

The shore A hardness of the flexible tube is preferably 50 to 75 degrees. When the shore A hardness of the flexible tube is smaller than 50 degrees, the flexible tube is too soft and thus it is difficult to obtain good compression recovery properties. Additionally, when the shore A hardness of the flexible tube is greater than 75 degrees, the flexible tube is too hard and thus it is difficult to obtain good compression recovery properties. When the shore A hardness of the flexible tube is a value within the above range, compression recovery properties suitable as a circular flexible tube used for roller pumps can be achieved. It should be noted that the shore A hardness of a flexible tube can be measured by “Rubber, vulcanized or thermoplastic—Determination of hardness—Part 3: Durometer method (JIS K 6253)”.

The elongation percentage of the flexible tube is preferably 700% to 1000%. When the elongation percentage of the flexible tube is a value within such range, deterioration of the elasticity and compression recovery properties of the flexible tube, which is caused when the flexible tube is repeatedly compressed by a roller pump, can be suppressed, and the durability of the flexible tube can be increased. It should be noted that the elongation percentage of a flexible tube can be measured at a tensile speed of 200 mm/min using dumbbell shaped No. 5 by “Rubber, vulcanized or thermoplastic—Determination of tensile stress-strain properties (JIS K 6251)”.

The flexible tube of the present embodiment is preferably a flexible tube for roller pumps. The flexible tube of the present embodiment can achieve excellent non-migration properties and compression recovery properties as described above. Because of this, the flexible tube of the present embodiment is suitable as a flexible tube for roller pumps, which is required to have compression recovery properties and non-migration properties.

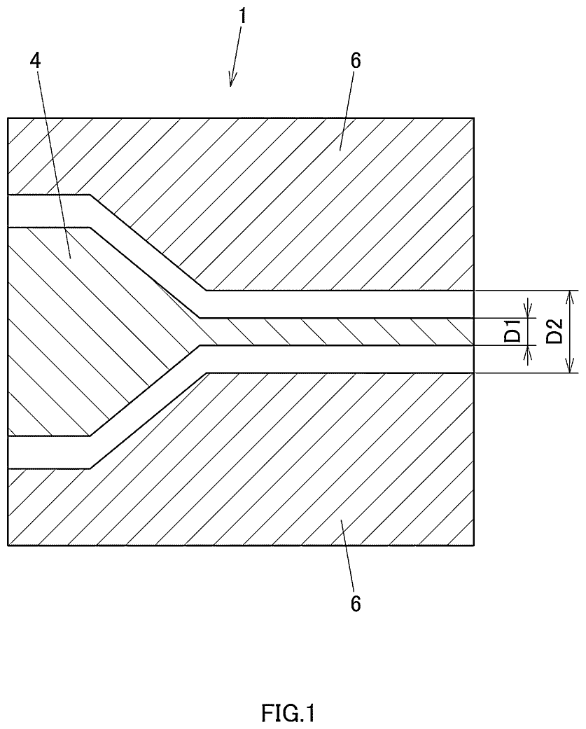

A method for producing the flexible tube for use in roller pumps according to the embodiment of the present disclosure will now be described. The flexible tube according to the embodiment can be produced by extrusion molding. That is, a resin composition having a styrene-based elastomer as a main component is charged into an extruder (charging step), and the charged resin composition is extruded to produce a flexible tube (forming step). At this time, extrusion molding is performed using e.g. a mold 1 (nipple 4, dies 6) as shown in FIG. 1 so that the draw down ratio in the inner diameter of the flexible tube formed will be 0.8 to 1.1. It should be noted that about the method for calculating the draw down ratio, the ratio of the inner diameter (mm) of the flexible tube after being formed to the outer diameter D1 (mm) of the nipple 4 is considered the draw down ratio of the inner diameter of the flexible tube, and the ratio of the outer diameter (mm) of the flexible tube after being formed to the inner diameter D2 (mm) of the dies 6 is considered the draw down ratio of the outer diameter of the flexible tube.

As described above, a flexible tube having a surface roughness Ra of the inner surface of 1.5 μm or less can be produced by extrusion molding using the mold 1 in which the draw down ratio is specified within the above range. In other words, a circular flexible tube with a uniform thickness according to the embodiment can be produced by extrusion molding of the resin composition having a styrene-based elastomer as a main component so that the draw down ratio in the inner diameter of the flexible tube produced will be 0.8 to 1.1.

In the above forming step, extrusion molding is preferably performed so that the draw down ratio in the outer diameter of the flexible tube will be higher than the draw down ratio in the inner diameter of the flexible tube. Therefore, the thickness of the flexible tube produced by extrusion molding can be adjusted by changing the draw down ratio in the outer diameter of the flexible tube (by changing gaps between the nipple and the dies) while the draw down ratio in the inner diameter of the flexible tube is within a range from 0.8 to 1.1 in the extrusion molding. Because of this, a flexible tube with an optional thickness having a surface roughness Ra of the inner surface of 1.5 μm or less can be achieved.

The flexible tube of the present embodiment which has been described above is formed from a flexible tube having a styrene-based elastomer as a main component, and therefore good compression recovery properties, transparency and non-migration properties can be obtained. Furthermore, when the surface roughness Ra of the inner surface of the flexible tube is 1.5 μm or less and moreover the ratio of the maximum height Rz to the arithmetic average roughness Ra of the inner surface of the flexible tube Rz/Ra is 10 or less, the irregularities on the inner surface are reduced, the smoothness of the inner surface is high, and the area coming into contact with a fluid in the flexible tube becomes smaller. Therefore, non-migration properties by which the components of the flexible tube are difficult to migrate can be excellent. The flexible tube having such surface roughness can be produced by charging a resin composition having a styrene-based elastomer as a main component into an extruder and specifying that the draw down ratio in the inner diameter of the flexible tube is 0.8 to 1.1 in the production process by extrusion molding. Consequently, a flexible tube having good compression recovery properties and excellent non-migration properties can be achieved. Therefore, the flexible tube according to the present embodiment can be suitably used as a flexible tube for roller pumps in the fields of food manufacturing, medicine manufacturing, chemical manufacturing, etc.

The embodiment of the present disclosure has been described above. It should be noted, however, that the present disclosure is not limited to the above embodiment, and various modifications can be made without departing from the main points thereof.

### EXAMPLE 1

### (1) Preparation of Flexible Tube Samples

The present disclosure will now be described in detail by way of examples thereof. In Examples, flexible tube samples having a styrene-based elastomer as a main component as Examples 1 and 2, and flexible tube samples having an olefin-based elastomer as a main component as Comparative Examples 1 and 2 were prepared, respectively. The measurement of the surface roughness of the inner surface of the flexible tubes and the migration test were carried out for each sample. In the migration test, furthermore, in order to compare differences in migration performance when using a maker different from the manufacturer of Examples 1 and 2, a flexible tube sample having a styrene-based elastomer as a main component was prepared as Example 3, and also in order to compare differences in the migration performance due to differences in grades from Comparative Example 2, a flexible tube sample having an olefin-based elastomer as a main component was further prepared as Comparative Example 3.

The flexible tubes prepared as Examples 1, 2 and 3 were produced by the same production method as in the above embodiment. “Tefabloc ME5309C” manufactured by Mitsubishi Chemical Group Corporation was used as a resin composition and extruded to form Example 1. “Tefabloc ME6301C” manufactured by Mitsubishi Chemical Group Corporation was used as a resin composition and was extruded to form Example 2. “AR875C” manufactured by ARONKASEI CO., LTD. was used as a resin composition and extruded to form Example 3. “PharMed BPT” manufactured by Saint-Gobain was prepared as a flexible tube in Comparative Example 1. “MediL P640I” and “MediL T740C” manufactured by TIGERS POLYMER CORPORATION were prepared as flexible tubes in Comparative Examples 2 and 3, respectively.

### (2) Measurement of Surface Roughness

The arithmetic average roughness Ra, the maximum height Rz and the ratio of the maximum height Rz to the arithmetic average roughness Ra Rz/Ra were each measured for each sample in Examples 1 and 2, and Comparative Examples 1 and 2. The measurement results are shown in Table 1 below. It should be noted that the surface roughness of the hose inner surface and hose outer surface were each measured in the longitudinal direction using “Surfcorder SE500A” manufactured by Kosaka Laboratory Ltd. as a measuring device. As the measurement conditions, the feeding speed was 0.5 mm/sec and the measurement length was 2,000 mm.

TABLE 1

| | Example | Example | Comparative | Comparative |
|---|---|---|---|---|
| | 1 | 2 | Example 1 | Example 2 |
| Arithmetic | 1.376 | 0.22 | 2.196 | 1.236 |
| average roughness | | | | |
| Ra (μm) | | | | |
| Maximum height Rz | 5.4 | 3.75 | 14.5 | 10 |
| (μm) | | | | |
| Rz/Ra | 3.9 | 17.0 | 6.6 | 8.1 |

From the results shown in Table 1, in Example 1 produced by the production method in the above embodiment, the measurement results were obtained in which the arithmetic average roughness Ra was 1.5 μm or less, the maximum height Rz was 7 μm or less, and Rz/Ra was 10 or less. Also, in Example 2 produced by the production method in the above embodiment, the measurement results were obtained in which the arithmetic average roughness Ra was 1.5 μm or less, and the maximum height Rz was 7 μm or less. In Comparative Example 1, the measurement results were obtained in which the arithmetic average roughness Ra was greater than 1.5 μm, and the maximum height Rz was greater than 7 μm. In Comparative Example 2, the measurement results were obtained in which the arithmetic average roughness Ra was smaller than 1.5, and the maximum height Rz was greater than 7 μm.

As described above, in Examples 1 and 2, the arithmetic average roughness Ra was a small value compared to the value in Comparative Example 1 and the maximum height Rz was a small value compared to the values in Comparative Examples 1 and 2, and it could be verified that the smoothness of the inner surfaces of the flexible tubes was excellent compared to that in Comparative Examples 1 and 2. When comparing Example 1 and Example 2, Rz/Ra was a value greater than 10 in Example 2, and it could be verified that the smoothness of the inner surface was more excellent in Example 1.

### (3) Migration Test

The material test, the migration test and the evaporation residue test were carried out for each sample in Examples 1, 2 and 3, and Comparative Examples 1, 2 and 3. Each of these tests was carried out in accordance with the test methods in “Standards and criteria for food and food additives, etc. (Ministry of Health, Labour and Welfare Notification No. 380 on Dec. 4, 2020)”. The results of each test are shown in Table 2 below.

TABLE 2

| | | | | | | Comparative | Comparative | Comparative |
|---|---|---|---|---|---|---|---|---|
| Test items | Reagent | Unit | Example 1 | Example 2 | Example 3 | Example 1 | Example 2 | Example 3 |
| Material | Cadmium | μg/g | 2.0 or less | 2.0 or less | 2.0 or less | 2.0 or less | 2.0 or less | 2.0 or less |
| test | Lead | μg/g | 20.0 or less | 20.0 or less | 20.0 or less | 20.0 or less | 20.0 or less | 20.0 or less |
| | Volatile | mg/g | 0.1 or less | 0.1 or less | 0.1 or less | — | — | — |
| | substances | | | | | | | |
| Migration | Heavy metal | μg/ml | 1.0 or less | 1.0 or less | 1.0 or less | 1.0 or less | 1.0 or less | 1.0 or less |
| test | (as lead) | | | | | | | |
| | Consumed | μg/ml | 0.9 | 0.8 | 0.7 | 0.8 | 0.8 | 0.9 |
| | amount of | | | | | | | |
| | potassium | | | | | | | |
| | permanganate | | | | | | | |
| Evaporation | Heptane | μg/ml | 14000 | 11000 | 12000 | 12000 | 11000 | 460 |
| residue | 20% Ethanol | μg/ml | 5.0 or less | 5.0 or less | 5.0 or less | 5.0 or less | 5.0 or less | 5.0 or less |
| | Water | μg/ml | 5.0 or less | 5.0 or less | 5.0 or less | 5.0 or less | 5.0 or less | 5.0 or less |
| | 4% Acetic acid | μg/ml | 5.0 or less | 5.0 or less | 5.0 or less | 6.0 | 5.0 or less | 5.0 or less |

As the results of the material test, the amounts of cadmium and lead were 100 μg/g or less as general specifications in all samples, and the amount of volatile substances was 5 mg/g or less as individual specifications in all samples. Therefore, Examples 1, 2 and 3 all conformed to the specifications and standards of the material test.

As the results of the migration test, the amount of heavy metal as lead was 1 μg/ml or less and the consumed amount of potassium permanganate was 10 μg/ml or less as general specifications in all samples. Therefore, Examples 1, 2 and 3 all conformed to the specifications and standards of the migration test.

As the results of the evaporation residue test, the amount of evaporation residue except for heptane was 30 μg/ml or less as individual specifications in all samples. Therefore, Examples 1, 2 and 3 all conformed to the specifications and standards of the evaporation residue test, and were lower than the standards in Comparative Examples 1, 2 and 3.

As described above, the samples in Examples 1, 2 and 3 all conformed to the specifications and standards of the migration test or had low migration, and could be verified that excellent low migration properties could be achieved. The measurement results of the surface roughness could also verify that between Examples 1 and 2, the sample in Example 1 had the most excellent smoothness of the inner surface of the flexible tube, thereby supposing that among Examples 1, 2 and 3, the sample in Example 1 has the most excellent non-migration properties.

What is claimed is:

1. A flexible tube having a styrene-based elastomer as a main component, which is formed by extrusion molding so that a draw down ratio in an inner diameter will be 0.8 to 1.1,
wherein an arithmetic average roughness Ra of an inner surface of the flexible tube is 1.5 μm or less, and a maximum height Rz of an inner surface of the flexible tube is 7 μm or less,
an amount of evaporation residue except for heptane in the flexible tube, which is measured in accordance with a test method in Standards and criteria for food and food additives, etc. (Ministry of Health, Labour and Welfare Notification No. 380 on Dec. 4, 2020), is 30 μg/ml or less, and
a ratio of the maximum height Rz to the arithmetic average roughness Ra of an inner surface of the flexible tube Rz/Ra is 3.9 or less.

2. The flexible tube according to claim 1, wherein a surface roughness Ra of an outer surface of the flexible tube is within a range of 20 μm or less.

3. The flexible tube according to claim 1, wherein shore A hardness of the flexible tube is 50 to 75 degrees.

4. The flexible tube according to claim 2, wherein shore A hardness of the flexible tube is 50 to 75 degrees.

5. The flexible tube according to claims 1, wherein an elongation percentage of the flexible tube is 700% to 1000%.

6. The flexible tube according to claims 2, wherein an elongation percentage of the flexible tube is 700% to 1000%.

7. The flexible tube according to claims 3, wherein an elongation percentage of the flexible tube is 700% to 1000%.

8. The flexible tube according to claim 1, which is a flexible tube for roller pumps.

9. The flexible tube according to claim 2, which is a flexible tube for roller pumps.

10. The flexible tube according to claim 3, which is a flexible tube for roller pumps.

11. The flexible tube according to claim 4, which is a flexible tube for roller pumps.
